(19) United States
(12) Patent Application Publication
(10) Pub. No.: US 2010/0204028 A1
(43) Pub. Date: Aug. 12, 2010

(54) System for Changing and Inserting or Placing Tools on a Machine Tool and Tool Magazine for Storing Tools

(75) Inventor: Alfred Geissler, Pfronten (DE)

Correspondence Address: BLAKELY SOKOLOFF TAYLOR & ZAFMAN LLP, 1279 OAKMEAD PARKWAY, SUNNYVALE, CA, 94085-4040, US

(73) Assignee: DECKEL MAHO PFRONTEN GMBH, Pfronten (DE)

(21) Appl. No.: 12/703,572

(22) Filed: Feb. 10, 2010

(30) Foreign Application Priority Data
Feb. 12, 2009 (DE) 102009008647.1

(51) Int. Cl. B23Q 3/157; B23Q 3/155

(52) U.S. Cl. 483/51; 483/58; 483/69

(57) ABSTRACT

The present invention relates to a system for changing and inserting or placing tools on a machine tool, comprising a tool magazine for storing a plurality of tools and a handling device for taking the tools out of the tool magazine, wherein according to the invention the tool magazine is formed such that the tools are stored on top of each other on different levels inside the tool magazine, the levels overlapping each other such that compartments for receiving the tools are formed which are each arranged on the levels along a circular arc or a circular arc segment, and the handling device being adapted to take the tools out of the compartments radially inwardly and/or radially outwardly. Furthermore, the present invention relates to a tool magazine of such system and a machine tool in combination with such system.

### TECHNICAL FIELD

The present invention relates to a system for changing and inserting or placing tools on a machine tool and a tool magazine for storing tools, a tool magazine for storing a plurality of tools, and a machine tool for machining a workpiece.

Particularly, the invention relates to a system for changing and inserting or placing tools on a machine tool, comprising a tool magazine for storing a plurality of tools, a handling device for taking the tools out of the tool magazine, a machine tool for machining a workpiece having a tool exchanger for changing a tool on the machine tool and a system for changing and inserting or placing tools on the machine tool, the handling device of the tool magazine being suitable to supply a tool from the tool magazine to the tool changer.

### BACKGROUND

The prior art discloses systems for changing and inserting or placing tools on a machine tool for storing a plurality of tools, in particular tool magazines for storing tools for tool stockpiling of a machine tool, in different embodiments.

Such tool magazines are suitable to receive or store a plurality of tools for tool stockpiling and furthermore comprise a handling device for taking the tools out of the tool magazine so that they can be supplied to a tool changer of a machine tool. In this process, it is possible in machine tools of the prior art to perform a tool exchange wherein a tool received on a spindle of the machine tool is replaced by another tool. This is optionally done fully automatically and by program-control. If during the machining of a workpiece on the machine tool tools are not needed at the current machining time, they are kept in a tool magazine for tool stockpiling.

In such cases two basic types of design of tool magazines are particularly disclosed by the prior art which differ in that either compartments or receiving means of the tool magazine for storing or receiving tools are rigid and a handling device is suitable to move a take-out unit of the handling device to the compartments or receiving means for taking out the tools or that a handling device of the tool magazine is rigid and compartments or receiving means for storing or receiving tools are moved to a take-out unit of the handling device.

The prior art discloses chain magazines for machine tools having a rigid handling device, e.g. from DE 39 05 780 C1 and DE 10 2005 052353 A1. Such chain magazines comprise a chain including a plurality of receiving means or receiving portions for receiving tools along the course thereof, the chain being guided at least in part along a guiding rail.

However, for flexibly machining workpieces on present-day machine tools it is particularly necessary to provide or store a large number of different tools in a tool magazine, wherein the problem arises in the above-described chain magazines that either a plurality of chains or chain magazines or unsuitably large chains must be provided for the tool stockpiling of a large number of tools. This leads to the fact that a large floor space is needed for the chain magazine, and furthermore possibly long tool providing times will occur in chain magazines if a tool is to be taken out of the chain magazine, which is accommodated on the chain of the chain magazine at a distance from the handling device.

Furthermore, in the prior art shelf magazines having rigid receiving means or compartments and a take-out unit that can be controlled for taking out the tools is disclosed e.g. in DE 10 334 346 A1.

However, in shelf magazines according to the prior art the problem arises that for storing a large number of different tools by the take-out unit of a handling device, long tool providing times may occur depending on the tool stockpiling and the control possibilities and in particular large floor spaces are required for the shelf magazine.

On the basis of a handling system for shelf magazines, DE 299 02 127 U1 describes a carousel magazine in which as a handling device for taking out the tools an articulated robot having 6 axes is used for taking out the tools or handling the tools. In particular, DE 299 02 127 U1 describes a carousel magazine in which tools of a machine tool are stored tribune-like on levels, the above-described articulated robot comprising 6 axes being adapted to receive the tools accommodated in the carousel magazine from above and supply them to a machine tool for a tool change that is optionally program-controlled.

The tribune shape is explained by the fact that it is necessary to guide the articulated robot or take-out units of the articulated robot for gripping or taking out the tools from above towards the tools stockpiled in the carousel magazine. However, due to the tribune shape required by the articulated robot, such carousel magazine has the problem that in such carousel magazine for stockpiling a very large number of tools a large number of tribune steps or levels with a downwardly increasing space or area requirement is necessary so that here unsuitably large floor spaces are needed for the carousel magazine. In addition, the control of such an articulated robot comprising 6 axes, in particular a program-controlled control, is very intricate and technically complex. Furthermore, due to the tribune shape it is difficult for an operator to inspect the stored tools from outside.

### SUMMARY OF THE INVENTION

Thus, it is an object of the present invention to provide a system for changing and inserting or placing tools on a machine tool, a tool magazine for storing tools, and a machine tool for machining a workpiece, comprising a system for changing and inserting or placing tools on the machine tool in which the above-mentioned problems of the chain, shelf and carousel magazines disclosed by the prior art are avoided.

Particularly, it is another object of the present invention to provide a system for changing and inserting or placing tools on a machine tool, a tool magazine for receiving tools, and a machine tool comprising a system for changing and inserting or placing tools on the machine tool, in which a large number of tools can be received for storing the tools and short tool providing times for the received tools are made possible.

According to the invention, the above-described objects are achieved by a system for changing and inserting or placing tools on a machine tool, a tool magazine for storing a plurality of tools and a machine tool comprising a system for changing and inserting or placing tools on the machine tool. Preferred embodiments of the present invention are described in the dependent claims.

A system for changing and inserting or placing tools on a machine tool according to the present invention comprises a tool magazine for storing a plurality of tools and a handling device for taking the tools out of the tool magazine. The system for changing and inserting or placing tools on a machine tool according to the present invention is particularly characterized in that the tool magazine is formed such that the tools are stored on top of each other on different levels inside the tool magazine, the levels overlapping each other such that compartments for receiving the tools are formed which are each arranged along a circular arc or a circular arc segment on the levels, and the handling device is adapted to take the tools out of the compartments radially inwardly and/or radially outwardly.

This offers the advantages, in particular due to the geometric arrangement of compartments and/or receiving means for receiving and/or storing tools in stacked levels and overlapping areas along a circular arc or circular arc segment on the respective levels, that an improved space utilization can be achieved in which a large number of tools can be stored while at the same time the floor space for the tool magazine is small. Here, suitably short tool providing times are made possible even in case of a large number of stored tools because the geometric arrangement of the tools and receiving means, respectively, for storing the tools advantageously ensures good accessibility of the tools for the handling device. In particular, comparatively short moving distances in the handling system result for all tools due to the circular arrangement on one level.

Compartments and receiving means, respectively, of the tool magazine are not limited as to their embodiment, and common receiving means, receiving portions or compartments for storing tools are possible, if the tools can be taken out radially inwardly and/or radially outwardly. For example, these may be compartments between the levels, which are optionally separated on one side or both sides by cross bracings of adjacent compartments of one of the levels, which are essentially orthogonal to the levels. However, the compartments may also be formed by any type of common receiving means for storing tools, for example by tongs for receiving tools. Preferably, one or more moldings substantially semi-open to the top are respectively formed on the bottom side of the compartments, which make it possible to fittingly deposit a tool.

Preferably, the handling device comprises a take-out unit and one or more linear axes as well as one or more rotational axes for moving the take-out unit. Thus, it is possible to move the take-out unit for taking the tools out of the compartments by means of the linear and rotational axes of the handling device to the stored tools and the compartments, respectively. Furthermore, it is preferably possible to supply tools to the compartments by means of the take-out unit for receiving the tools in the compartments.

To this end, the handling device preferably comprises a first linear axis for moving the take-out unit in a radial direction which makes it possible to move the take-out unit on one level of the different levels in a radial direction, particularly for taking out the tools in a radial direction radially outwardly and/or radially inwardly.

Furthermore, the handling device preferably comprises a first rotational axis for aligning the first linear axis on one cross-sectional level of the tool magazine. This has the advantage that the orientation or alignment of the radial direction in which the take-out unit can be moved in a radial direction by means of the first linear axis for taking out the tools makes an alignment to one of the tools stored on a circular arc or circular arc segment possible inside one of the different levels.

Preferably, the handling device comprises a second linear axis for moving the take-out unit between the different stacked levels. This offers the advantage that the take-out unit can be moved from one of the levels to a particular other level, for example, when a tool to be taken out is stored on the particular other level.

Preferably, the second linear axis for moving the take-out unit between the different stacked levels is a telescopic axis which is adapted to move the take-out unit vertically according to the telescope principle and/or between the different levels.

This offers the advantage that due to the formation of a vertical axis of the handling device as a telescopic axis a compact structure of the handling device including simple operation and handling can be provided. Furthermore, it is thus possible in an advantageous manner to add further levels comprising further compartments for receiving tools to the tool magazine in order to increase the tool receiving capacity of the tool magazine, wherein the handling device can be used further without a required complicated adaptation to a higher number of different levels because the telescopic axis makes it possible to move the take-out unit to the added levels.

Particularly, the handling device comprises the first linear axis, the second linear axis and the first rotational axis so that the take-out unit can be moved to a particular stored tool by means of three axes for taking out a tool in order to take out the particular tool radially inwardly and/or radially outwardly. To this end, it is possible to access a particular tool or compartment in which the particular tool is stored by moving the take-out unit by the second linear axis to the level in which the particular tool is stored by moving the take-out unit by the first rotational axis such that the alignment of the first linear axis is oriented in the radial direction of the stored tool, and by moving the take-out unit by the first linear axis in the radial direction to the tool.

Furthermore, the handling device preferably comprises a third linear axis for moving the take-out unit to a tool changer for changing a tool on the machine tool. Thus, a further linear axis is provided in an advantageous manner which makes it possible, preferably in combination with the above-described linear and rotational axes, to supply a taken-out tool to a tool changer so that the tool can be exchanged or replaced on the machine tool.

Preferably, the handling device is adapted to supply a tool taken from the compartments to a tool changer for exchanging or replacing a tool on the machine tool and/or directly exchange or replace it on a spindle (220) of a machine tool (200). Here, it is possible to directly exchange or replace a tool from the storage in a tool magazine into a spindle of a machine tool, for example, in accordance with a direct pick-and-place method.

Preferably, the tool magazine comprises a base frame which is substantially cylinder-shaped. Preferable, the base frame in this case is a cast construction or welded construction. Thus, due to the cylinder shape of the base frame, in particular due to the circular cross-section, it is possible to provide a suitably intrinsically stiff base frame for the tool magazine.

Preferably, the handling device is arranged inside the cylinder-shaped base frame. This has the advantage that for a tool take-out for all compartments suitably short moving distances of the take-out unit occur, in particular regarding a movement by a first linear axis and/or a first rotational axis, when the tools are taken out. In this case, the tools are preferably taken radially inwardly out of the compartments.

Preferably, take-out openings for taking the tools out of the compartments are formed in an inner peripheral surface of the cylinder.

Preferably, longitudinal axes of the compartments of the tool magazine extend in a radial alignment such that tools having a longitudinal extension are received in the compartments in a radial alignment and may optionally protrude from the compartments.

This offers the advantage that tools of different lengths having a longitudinal extension can be stored in the compartments whereby optimal space utilization is made possible by the radial orientation of the tools in a particularly advantageous manner because tools of different lengths can be stored in the same compartments and possibly protrude from the compartments in a radial direction.

Preferably, the handling device is adapted to take the tools radially inwardly out of the compartments, tools being received in the compartments such that a machining portion of the tools for machining a workpiece protrudes radially outwardly from the compartments.

This has the advantage that receiving portions of the tools, which are suitable in that the tool is received at the receiving portions, for example, by the take-out unit, receiving means of a tool changer or particularly receiving means on a spindle of a machine tool, are aligned radially inwardly in the tool magazine when they are stored, and accordingly portions of the tools, which are suitable to machine a workpiece are aligned radially outwardly in the tool magazine when they are stored. In this case it is particularly advantageous that machining portions of the tools that may be soiled by lubricating means or other soiling are directed radially outwardly, preferably even protrude radially outwardly from the compartments so that the receiving portions in the interior of the tool magazine can be kept clean.

A tool magazine for storing a plurality of tools according to the present invention is characterized in that the tool magazine is formed as a tool magazine of one of the above-described systems for changing and inserting or placing tools on a machine tool.

A machine tool for machining a tool according to the present invention comprises a tool changer for changing a tool on the machine tool and one of the above-described systems for changing and inserting or placing tools on the machine tool, the handling device of the tool magazine being suitable to supply a tool from the tool magazine to the tool changer.

The above-described summary of the invention essentially describes the taking-out of tools stored in the tool magazine and the supplying of a tool to a tool changer for respectively exchanging and replacing the tool on the machine tool. However, the inventive system for changing and inserting or placing tools on the machine tool, the inventive tool magazine and the inventive machine tool are also adapted to supply tools from the machine tool or the tool changer to the compartments of the tool magazine for storage by controlling and/or moving the take-out unit, preferably in analogy to the above-described taking-out and supplying of tools.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 shows a system for changing and inserting or placing tools according to an embodiment of the present invention in a side view from the right.

FIG. 2 shows a system for changing and inserting or placing tools according to an embodiment of the present invention in a front view.

FIG. 3 shows a system for changing and inserting or placing tools according to an embodiment of the present invention in a top view.

FIG. 4 shows a handling device according to an embodiment of the system for changing and inserting or placing tools according to the present invention in a side view.

FIG. 5 shows a system for changing and inserting or placing tools according to an embodiment of the present invention in a side view from the right in combination with a machine tool.

### DETAILED DESCRIPTION OF THE ILLUSTRATED EMBODIMENTS

Embodiments of a system for changing and inserting or placing tools on a machine tool and a tool magazine for storing tools, a tool magazine for storing a plurality of tools, and a machine tool for machining a workpiece are described herein with reference to the figures. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

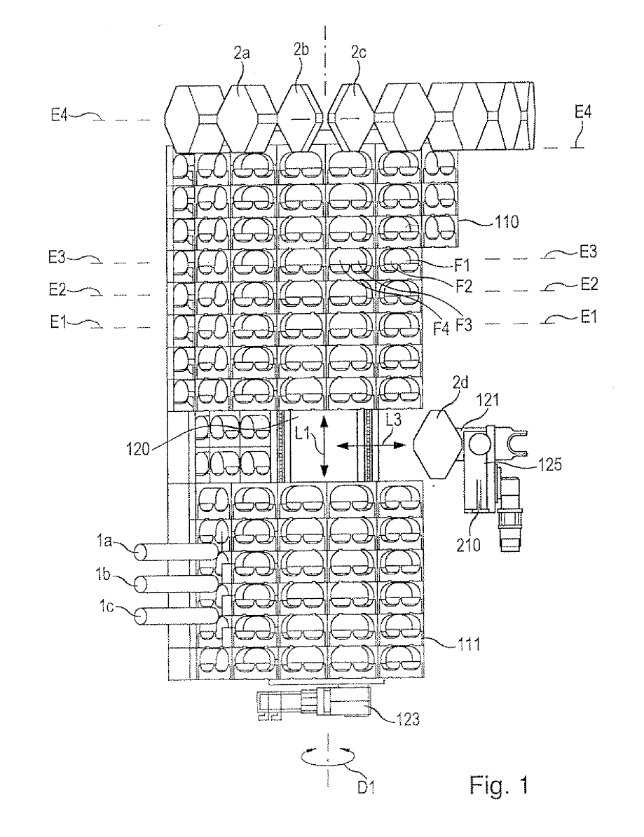

FIG. 1 shows an embodiment of the inventive system for changing and inserting or placing tools on a machine tool with a tool magazine 110 for storing a plurality of tools in a side view from the right, comprising a base frame 111, the base frame 111 being formed such that respective, adjacently placed compartments, for example, compartments F1 to F4, are formed in different stacked levels, e.g. levels E1 to E4, which compartments are suitable to receive tools of a machine tool for storage.

By way of example, FIG. 1 shows that tools 1a, 1b and 1c are accommodated for storage in a lower part of the base frame 111 of the tool magazine 110 in three levels on top of each other in respective stacked compartments.

According to this embodiment of the present invention the tool magazine 110 and the base frame 111, respectively, are formed such that the tools 1a, 1b, 1c are stored on top of each other on different levels inside the tool magazine 110, the levels overlapping each other such that the compartments for receiving the tools are formed. According to the embodiment of the present invention in FIG. 1, respective compartments (e.g. F1 to F4) are exemplarily formed such that a respective one of the compartments F1 to F4 is separated on one side from the respective adjacent compartment by a vertical cross bracing, and no vertical cross bracing is provided on the other side. Thus, according to this embodiment, there are always formed compartment pairs, for example, F1 and F2 or F3 and F4, which have no vertical cross bracing between the compartments of a compartment pair. However, the present invention is not limited to such embodiments but allows any design of the compartments or receiving means for storing the tools, which permits a storey-like arrangement of the stored tools lying substantially on a virtual cylinder barrel area.

In this embodiment it is possible to take tools stored in compartments of the tool magazine out of the compartments radially inwardly by using a take-out unit 121 of a handling device 120, the take-out unit 121 comprising three linear axes L1, L2 and L3 and a rotational axis D1 having a rotational axis drive 123 which are suitable to move the take-out unit in order to take tools out of the compartments or to insert them. The linear axes L1, L2 and L3 respectively allow a movement of a tool taken out by the handling device in a radial direction within one of the levels (first linear axis L1), for example into a compartment or out of a compartment, in a vertical direction between the levels (second linear axis L2) and in a transverse direction towards a tool changer of a machine tool (third linear axis L3). The rotational axis D1 allows the orientation of the radial alignment of the first linear axis L1 within one of the different levels towards a particular compartment. Thus, it is possible to drive the take-out unit optimally to each of the compartments by using the three linear axes L1, L2 and L3 and the rotational axis D1 and, at the same time, easy handling or technical operation.

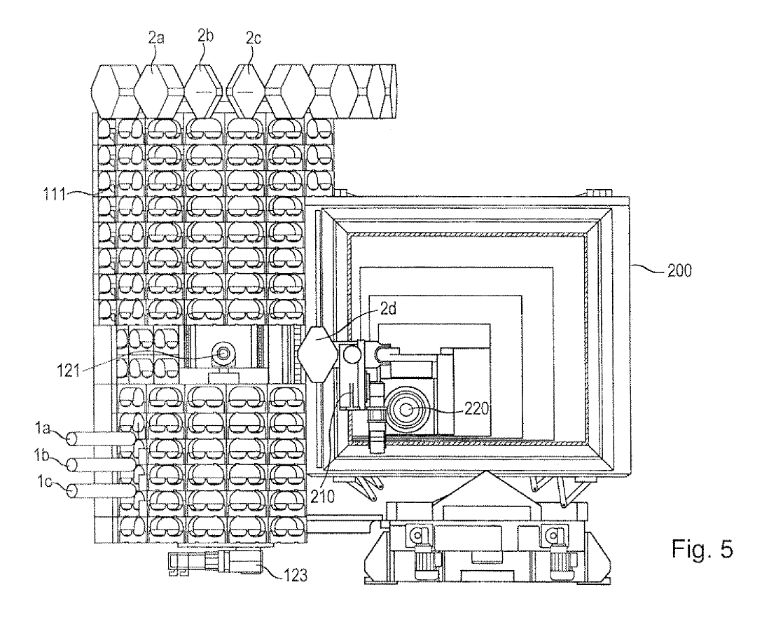

Furthermore, FIG. 1 shows that according to this embodiment a lateral opening is formed at a medium height in the base frame 111 of the tool magazine, which makes it possible to supply a tool 2d taken out of the interior of the tool magazine 110 to a tool changer 210 of a machine tool 200 at the height of a tool changer 210 (see also in particular FIG. 5) by using the take-out unit 121 by moving, for example, the tool changer 210 by means of the linear axis L3 (see also in particular FIG. 5). The above-described opening may optionally be used as access to the interior of the tool magazine, for example for maintenance work of e.g. the handling device.

Here, FIG. 1 furthermore shows means of the handling device 120 located outside the base frame, which comprise other means of the take-out unit for taking a tool out of the tool magazine 110, and a drive 125 for the linear axis L3.

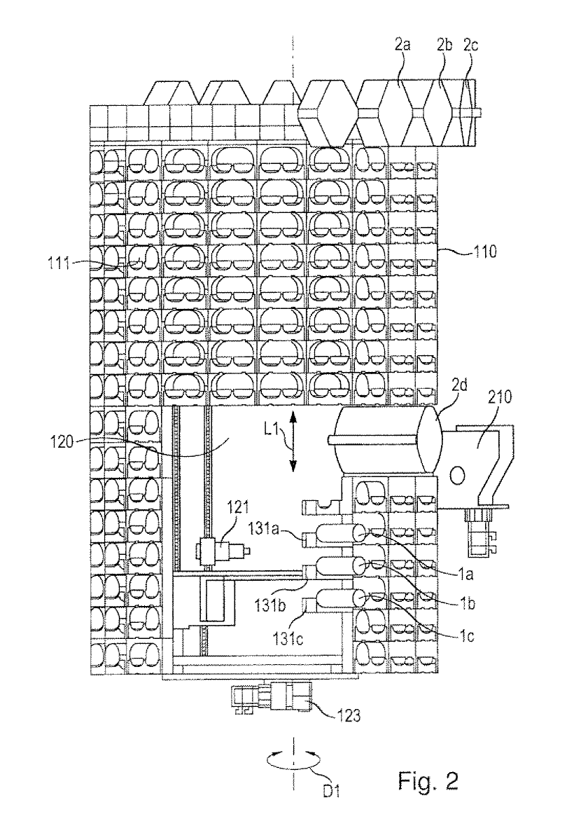

FIG. 2 shows the tool magazine 110 shown in FIG. 1 in a front view. Here, it is shown that the tools 1a, 1b and 1c are accommodated in insertion compartments 131a, 131b and 131c of an inserting unit of the system which is suitable to receive tools inserted by an operator into the insertion compartments 131a, 131b and 131c so that they can be inserted into free compartments of the tool magazine by the take-out unit 121 or can be supplied to them.

In the preferred embodiment of the present invention it is furthermore shown in FIGS. 1 and 2 by way of example that a top-most located level E4 has compartments for receiving large tools 2a, 2b and 2c, the compartments for receiving the tools 2a, 2b and 2c being arranged on a circular arc positioned on the top-most level E4.

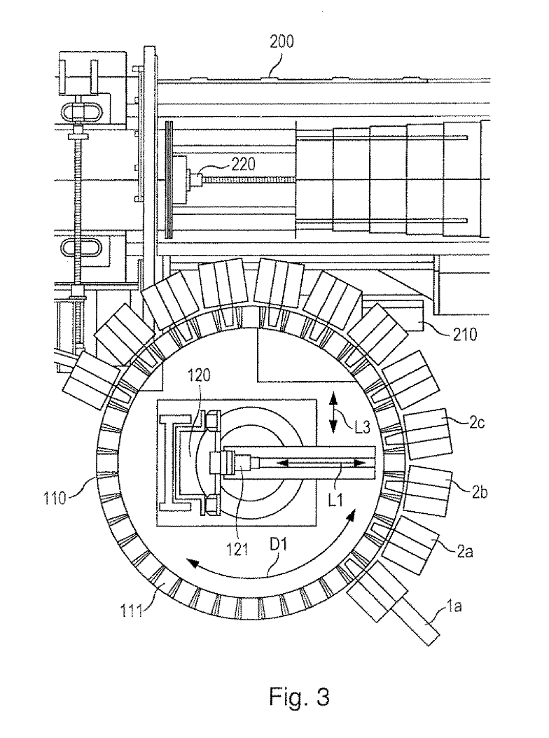

In particular, FIG. 3 shows the tool magazine 110 in a plan view illustrating the course of the circular arc of the top-most level E4 and the tools 2a, 2b and 2c stored along a circle or circular arc. By way of example, FIG. 3 furthermore shows the tool changer 210 and a spindle 220 of a machine tool 200.

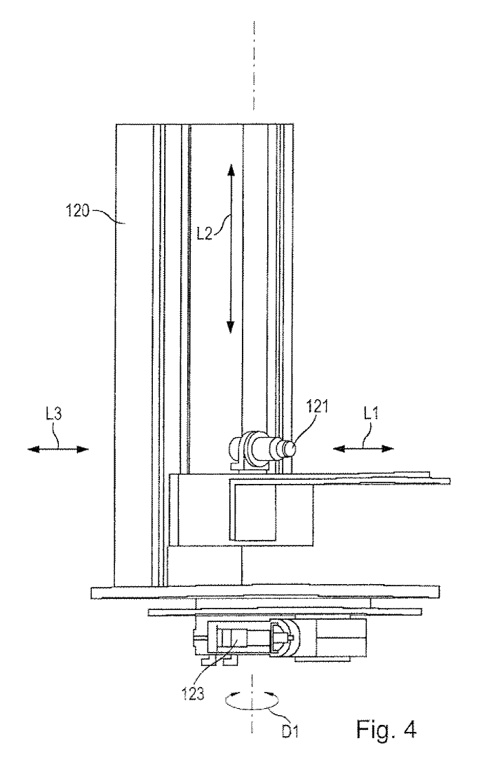

The handling device 120 according to this embodiment of the present invention is illustrated as an example in a side view in FIG. 4 (the drive 125 of the third linear axis L3 not being shown). The handling device 120 comprises the first linear axis L1 suitable to move the take-out unit 121 in a radial direction L1 in order to radially move the take-out unit 121 on one of the different levels for receiving a tool. For vertically moving the take-out unit 121, in particular between the different levels on which the tools are stored, the handling device 120 furthermore comprises a second linear axis L2 for moving the take-out unit 121 in a vertical direction L2 between the different levels. According to this embodiment of the present invention, the second linear axis exemplarily functions in accordance with the telescope principle, the present invention not being limited to a second linear axis according to the telescope principle. Moreover, the handling device 120 comprises a rotational axis D1 suitable to rotate the take-out unit 121 inside one of the different levels in a rotational direction D1 in order to rotate or align the first linear axis L1 inside one of the different levels in the desired radial direction in which a tool to be received is stored.

If a tool stored in the tool magazine 110 is to be received, the handling device 120 controls the take-out unit 121 such that the second linear axis L2 moves the take-out unit 121 to the particular level in which the tool to be received is stored, and furthermore the handling device 120 controls the take-out unit 121 such that the rotational axis D1 aligns the radial alignment of the first linear axis L1 in the direction of the particular stored tool so that for taking out the particular tool the take-out unit 121 is further moved by means of the first linear axis L1 radially to the tool for receiving the tool in order to take the tool radially inwardly out of the particular compartment in which the particular tool is stored. To this end, the take-out unit 121 comprises, for example, a tool clamping component for taking out the tool.

According to the above-described embodiment of the present invention, the tool magazine 110 particularly comprises a base frame 111 which is cylinder-shaped such that the arrangement of the compartments on the different levels of the tool magazine 110 is formed such that the compartments for receiving the tools have an equal radial distance to the axis of rotation of the rotational axis D1.

FIG. 5 shows a system for changing and inserting or placing tools according to an embodiment of the present invention in a front view according to FIG. 1, wherein a machine tool 200 including a spindle 220 and a tool changer 210 is additionally shown by way of example, which is adapted to exchange or replace a tool of the machine tool 200. For example, the tool changer 210 may comprise a common swivel-blade exchanger.

In particular, the inventive system for changing and inserting or placing tools according to an embodiment of the present invention provides a tool magazine which makes it possible to store a large number of tools while floor space of the tool magazine is small and the tool providing times are short. In particular, a tool magazine is provided in which the circular cross-section makes equal moving distances possible for all tools arranged on one level.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1-15. (canceled)

16. A system for changing and inserting or placing tools on a machine tool, the system comprising:
a tool magazine for storing a plurality of tools; and
a handling device for taking the tools out of the tool magazine, wherein the tool magazine is formed such that:
the tools are stored on top of each other on different levels inside the tool magazine,
the levels overlap each other such that compartments are formed for receiving the tools which each are arranged along a circular arc or a circular arc segment on the levels, and
the handling device is adapted to take the tools out of the compartments radially inwardly and/or radially outwardly.

17. The system of claim 16 wherein the handling device comprises a take-out unit and one or more linear axes as well as one or more rotational axes for moving the take-out unit.

18. The system of claim 17 wherein the handling device comprises a first linear axis for moving the take-out unit in a radial direction.

19. The system of claim 18 wherein the handling device comprises a first rotational axis for aligning the first linear axis in a cross-sectional plane of the tool magazine.

20. The system of claim 18 wherein the handling device comprises a second linear axis for moving the take-out unit between the different stacked levels.

21. The system of claim 20 wherein the second linear axis for moving the take-out unit between the different stacked levels is a telescopic axis.

22. The system of claim 20 wherein the handling device comprises a third linear axis for moving the take-out unit to a tool changer for changing a tool on the machine tool.

23. The system of claim 16 wherein the handling device is adapted to exchange or replace a tool taken out of the compartments directly in a spindle of a machine tool.

24. The system of claim 16 wherein the tool magazine comprises a base frame which is substantially cylinder-shaped.

25. The system of claim 24 wherein the handling device is arranged inside the cylinder-shaped base frame.

26. The system of claim 25 wherein take-out openings of the compartments are formed in an inner peripheral surface of the cylinder.

27. The system of claim 16 wherein a longitudinal axis of the compartments of the tool magazine extends in a radial alignment such that tools having a longitudinal extension are received in radial alignment in the compartments and may optionally protrude from the compartments.

28. The system of claim 27 wherein the handling device is adapted to take the tools out of the compartments radially inwardly, the tools being received in the compartments such that a machining portion of the tools for machining a workpiece protrudes radially outwardly from the compartments.

29. A tool magazine for storing a plurality of tools, the tool magazine comprising:
a plurality of different levels, wherein the tools are stored on top of each other on the different levels inside the tool magazine, and wherein the levels overlap each other such that compartments are formed for receiving the tools which each are arranged along a circular arc or a circular arc segment on the levels, and
wherein the tool magazine is adapted to allow a handling device to take the tools out of the compartments radially inwardly and/or radially outwardly.

30. The tool magazine of claim 29 wherein the tool magazine comprises a base frame which is substantially cylinder-shaped.

31. The tool magazine of claim 30 wherein the handling device, if present, is arranged inside the cylinder-shaped base frame.

32. The tool magazine of claim 30 wherein take-out openings of the compartments are formed in an inner peripheral surface of the cylinder.

33. The tool magazine of claim 29 wherein a longitudinal axis of the compartments of the tool magazine extends in a radial alignment such that tools having a longitudinal extension are received in radial alignment in the compartments and may optionally protrude from the compartments.

34. The tool magazine of claim 29 wherein the handling device, if present, is adapted to take the tools out of the compartments radially inwardly, the tools being received in the compartments such that a machining portion of the tools for machining a workpiece protrudes radially outwardly from the compartments.

35. A machine tool for machining a workpiece, the machine tool comprising:
a tool changer for changing a tool on the machine tool; and
a system for changing and inserting or placing tools on the machine tool, the system comprising:
a tool magazine for storing a plurality of tools; and
a handling device for taking the tools out of the tool magazine, wherein the tool magazine is formed such that:
the tools are stored on top of each other on different levels inside the tool magazine,
the levels overlap each other such that compartments are formed for receiving the tools which each are arranged along a circular arc or a circular arc segment on the levels, and
the handling device is adapted to take the tools out of the compartments radially inwardly and/or radially outwardly;
wherein the handling device can supply a tool from the tool magazine to the tool changer.

36. The machine tool of claim 35 wherein the handling device comprises a take-out unit and one or more linear axes as well as one or more rotational axes for moving the take-out unit.

37. The machine tool of claim 36 wherein the handling device comprises a first linear axis for moving the take-out unit in a radial direction.

38. The machine tool of claim 37 wherein the handling device comprises a first rotational axis for aligning the first linear axis in a cross-sectional plane of the tool magazine.

39. The machine tool of claim 37 wherein the handling device comprises a second linear axis for moving the take-out unit between the different stacked levels.

40. The machine tool of claim 39 wherein the second linear axis for moving the take-out unit between the different stacked levels is a telescopic axis.

41. The machine tool of claim 39 wherein the handling device comprises a third linear axis for moving the take-out unit to a tool changer for changing a tool on the machine tool.

42. The machine tool of claim 36 wherein the handling device is adapted to exchange or replace a tool taken out of the compartments directly in a spindle of a machine tool.

43. The machine tool of claim 35 wherein the tool magazine comprises a base frame which is substantially cylinder-shaped.

44. The machine tool of claim 43 wherein the handling device is arranged inside the cylinder-shaped base frame.

45. The machine tool of claim 43 wherein take-out openings of the compartments are formed in an inner peripheral surface of the cylinder.

46. The machine tool of claim 35 wherein a longitudinal axis of the compartments of the tool magazine extends in a radial alignment such that tools having a longitudinal extension are received in radial alignment in the compartments and may optionally protrude from the compartments.

47. The machine tool of claim 46 wherein the handling device is adapted to take the tools out of the compartments radially inwardly, the tools being received in the compartments such that a machining portion of the tools for machining a workpiece protrudes radially outwardly from the compartments.
